(19) United States
(12) Patent Application Publication
(10) Pub. No.: US 2005/0071179 A1
(43) Pub. Date: Mar. 31, 2005

(54) Dynamic processing of payment requests for mobile commerce transactions

(75) Inventors: Mark E. Peters, Chapel Hill, NC (US); David Richard Shepherd, Durham, NC (US); Mark Alan Sibert, Durham, NC (US); David Mark Soroka, Raleigh, NC (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/675,503

(22) Filed: Sep. 30, 2003

(51) Int. Cl. G06F 17/60

(52) U.S. Cl. 705/1; 705/40

(57) ABSTRACT

A mobile commerce system which has been configured in accordance with the present invention can include a multiplicity of mobile server wallets. Each wallet can have an association with a corresponding subscriber in a wireless service provider network. A proxy server can be disposed in the wireless service provider network. Finally, a filter plug-in can be coupled to the proxy server and configured to intercept selected payment messages flowing through the proxy server. The filter plug-in further can be configured to route the payment messages to selected ones of the mobile server wallets.

### BACKGROUND OF THE INVENTION

1. Statement of the Technical Field

The present invention relates to the field of mobile commerce and more particularly to processing payment requests with mobile server wallets in a payment transaction management network.

2. Description of the Related Art

Mobile commerce transactions are those e-commerce transactions which can be initiated through a mobile pervasive device such as a cellular telephone, personal digital assistant or a digital pager. Typical mobile commerce transactions include the purchase of goods or services, travel tickets including airfare and admission to venues such as sporting events, motion pictures or musical concerts. In a conventional e-commerce transaction, payment for the transaction can be cleared through a third-party payment system communicatively coupled to a Web server hosting the transaction. In this regard, the conventional e-commerce transaction can include a simple scheme of content browsing client, content server and payment clearance system.

Mobile commerce transactions differ from e-commerce transactions principally by way of the mobility of the pervasive device. Specifically, in addition to a content server and payment clearance system, a wireless service provider will be required to act as a gateway between a network of pervasive devices and the Internet. Importantly, given the mobility of pervasive devices in mobile commerce, mobile server wallets have been deployed to facilitate the exchange of payment information from the pervasive device of the shopper and the merchant payment clearance system. Mobile Server Wallets can store shipping information, billing information, payment methods, payment information and the like for the convenience both of the shopper and the merchant. Individual Mobile Server Wallets can be accessed by the merchant at checkout to facilitate the transaction without requiring the manual intervention of the shopper.

To provide to the shopper the convenience of a Mobile Server Wallet, a relationship must be established between the Wireless Service Provider and the Mobile Server Wallet Provider. Yet, by its very nature individual ones of pervasive devices may enjoy relationships with Mobile Server Wallet Providers which remain unknown to the Wireless Service Provider. In this regard, the Mobile Server Wallet Provider can be disposed within the Wireless Service Provider, within a separate Internet Service Provider, within the content servers of financial institutions, within the transaction processing facilities of individual merchants, or within a content portal. Nevertheless, regardless of the identity of the Mobile Server Wallet Provider, the Wireless Service Provider must know this identity to properly route payment messages.

FIG. 1 is a schematic illustration of a well-known mobile transaction architecture in which payment messages can be routed through a Mobile Server Wallet Provider disposed within a wireless network. The architecture of the known art can include a wireless services gateway 140 coupled to a mobile service wallet provider (MSWP) 120 within a wireless service provider network. In operation, a user mobile device 110 can communicate with an on-line store 150 through both wireless and wire-bound portions of the global Internet.

When consummating a transaction, the MSWP 120 can intercept the “checkout page” and can process the checkout page in association with the mobile server wallet (not shown) provided by the user mobile device 110. Specifically, the MSWP 120 can route the payment transaction to a suitable payment issuer 160 disposed among a multitude of payment issuers 130. The payment issuer 160 can process the transaction to produce a commitment of payment. Subsequently, the payment issuer 160 can route the commitment to the on-line store 150 through the MSWP 120.

Importantly, it will be recognized by the skilled artisan that substantial infrastructure will be required to support the MSWP 120 within the wireless network. Minimally, the MSWP 120 must include a full-fledged operating system, a database management system and an application server. Yet, the foregoing architecture hardly represents a minimally invasive configuration. Additionally, the architecture of FIG. 1 cannot scale to support the dynamic selection of different mobile server wallets through multiple MSWPs. Rather, the architecture of FIG. 1 largely is statically configured for use with particular mobile server wallets and specific payment issuers. Thus, the architecture of FIG. 1 demonstrates several deficiencies of the state of the art.

### SUMMARY OF THE INVENTION

The present invention addresses the deficiencies of the art in respect to payment transaction management and provides a novel and non-obvious method, system and apparatus for routing payment transactions in a wireless network to dynamically chosen mobile server wallets which can be applied in the processing of the payment transactions. A mobile commerce system which has been configured in accordance with the present invention can include a multiplicity of mobile server wallets. Each wallet can have an association with a corresponding subscriber in a wireless service provider network. A proxy server can be disposed in the wireless service provider network. Finally, a filter plug-in can be coupled to the proxy server and configured to intercept selected payment messages flowing through the proxy server. The filter plug-in further can be configured to route the payment messages to selected ones of the mobile server wallets.

Notably, the mobile commerce system can include one or more profiles communicatively linked to the filter plug-in. Each of the profiles can specify a merchant configured to engage in mobile commerce transactions through the wireless service provider network. The filter plug-in further can have a configuration for routing the payment messages to the mobile server wallets when a source of the payment messages matches a merchant identity specified in at least one of the profiles. Optionally, individual ones of the mobile server wallets can be disposed in at least one of an Internet service provider server, the wireless service provider network server, a merchant server, a financial institution server and a portal server.

A method for processing mobile commerce transactions in a wireless service provider network can include the step of filtering payment messages flowing between merchants and subscribers to the wireless service provider network. Through filtering, specific payment messages associated with specific subscribers in the wireless service provider network can be identified. Consequently, filtered ones of the payment messages can be routed to specified mobile server wallets associated with the specific subscribers. In this regard, the mobile server wallets can be selectably specified by the subscribers, such as when the subscribers log in to the wireless network. Importantly, filters can be consulted which specify specific ones of the merchants. Message traffic flowing from the merchants can be monitored and the filter can intervene in those purchase transactions originating in the merchants to facilitate the consummation of the purchase transaction.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is schematic illustration of a payment transaction management system known in the state of the art;

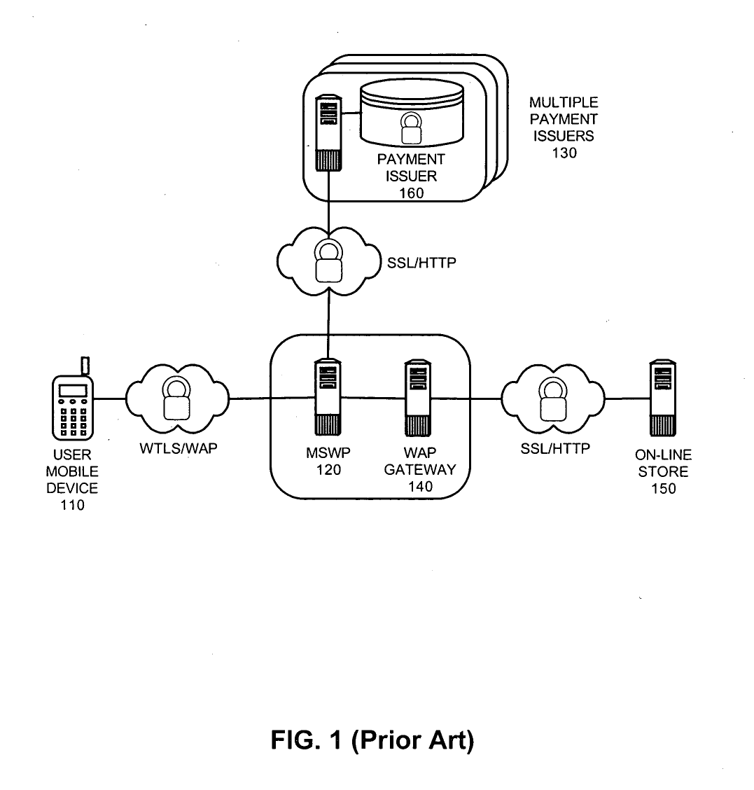

FIG. 2 is a schematic illustration of a payment transaction management system which has been configured in accordance with a preferred aspect of the present invention; and,

FIG. 3 is a flow chart illustrating a process for filtering the management of a payment request in the payment transaction management system of FIG. 2.

### DETAILED DESCRIPTION OF THE PREFERRED EMBODIMENTS

The present invention is a plug-in to a content routing proxy for routing payment messages to selected mobile server wallets supported by corresponding MSWPs. The routing proxy can be disposed in a wireless service provider network established to support a multitude of pervasive devices through wireless communications links. The plug-in can intercept payment messages sent between a merchant computing system and a pervasive device of a subscriber to the wireless service provider network. An association between one of the subscriber or the merchant and a particular mobile server wallet can be established. Subsequently, the plug-in can route the payment message to a corresponding MSWP in which the payment message can be processed.

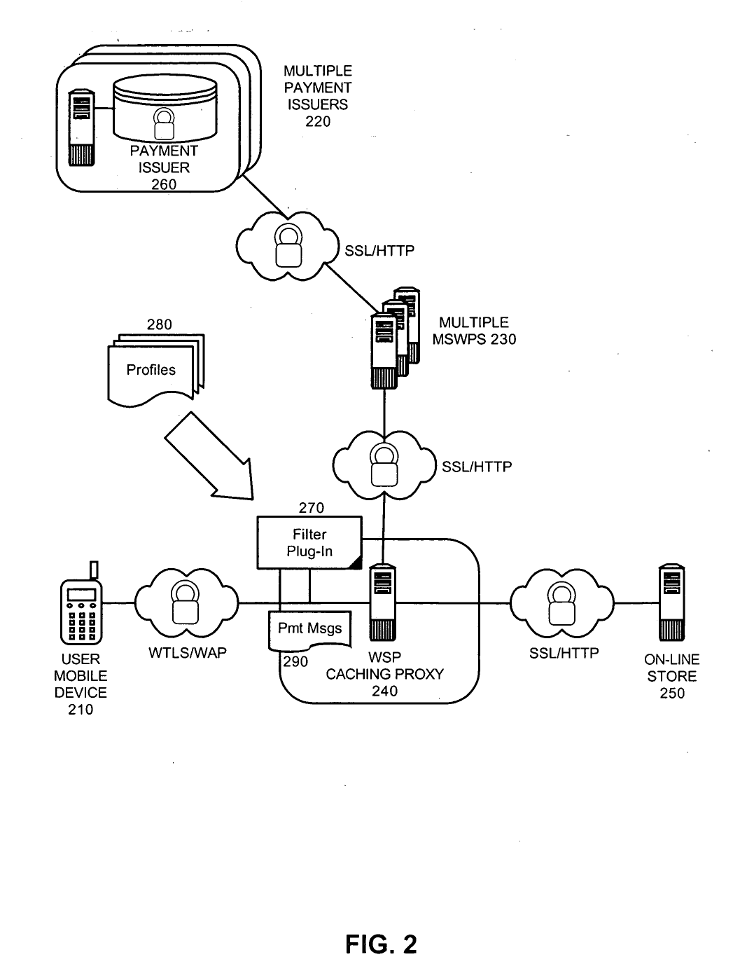

FIG. 2 is a schematic illustration of a payment transaction management system disposed in a wireless service provider network which network has been configured in accordance with a preferred aspect of the present invention. The payment transaction management system can include a multiplicity of MSWPs 230 communicatively coupled to one or more payment issuers 220. Each one of the MSWPs 230 can obtain a guarantee of payment from a payment issuer 260 among the multiple payment issuers 220 for a purchaser associated with a mobile server wallet managed by the MSWP 230. The process of obtaining a guarantee of payment can be linked to the interception of a payment message 290 between a merchant 250 and a pervasive device 210 in the wireless server provider network.

More specifically, a filter plug-in 270 can be programmatically coupled to a routing proxy server 240 disposed within the wireless server provider network. For example, the routing proxy server 240 can be a caching proxy server such as the WebSphere™ Everyplace Server™ manufactured by IBM Corporation of Armonk, N.Y., United States. In any case, the filter plug-in 270 can read data flowing through the proxy server 240 to identify data of interest. In accordance with the inventive arrangements, data of interest can be a payment message associated with a particular subscriber, a particular pervasive device, a particular merchant, or any other identifying characteristic. Notably, by “keying” the filter plug-in 270 to specific subscribers, the routing operation of the plug-in 270 can be limited to those subscribers who use mobile server wallets.

Once a payment message 290 has been identified as meeting the criteria of a filter configured within the filter plug-in 270, the payment message 290 can be routed to a specific mobile server wallet managed by a corresponding one of the MSWPs 230. The corresponding one of the MSWPs 230, in turn, can obtain a guarantee of payment from a specific payment issuer 260 from among the multiple payment issuers 220. Once a guarantee of payment can be obtained, the MSWPs 230 can return the payment information within a payment message 290 intended for the merchant system 250. In this regard, the payment message 290 can be a completed “checkout” page.

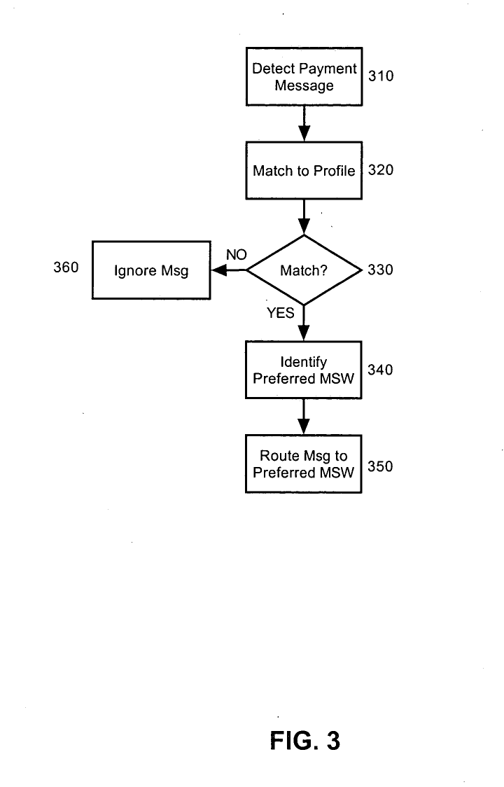

Importantly, it will be recognized by the skilled artisan that unlike conventional payment transaction processing known in the prior art in which all payment messages are processed statically within a fixed MSWP within the wireless service provider network, in the system of the present invention the filter plug-in 270 can avoid the consumption of excessive overhead by filtering only those payment messages 290 which can be acted upon based on an association with a particular subscriber, particular merchant, particular content, or other such filtering characteristic. To that end, FIG. 3 is a flow chart illustrating a process for filtering the management of a payment request in the payment transaction management system of FIG. 2.

Beginning in block 310, a payment message can be detected as the message flows through a proxy server in the wireless service provider network. In block 320, an aspect of the message, for instance a recipient address or sending address, can be compared to a filter to determine whether the payment message ought to be processed in the filter, or ignored. In decision block 330, if the filter indicates a match between the aspect of the payment message and the filter, in block 340 a preferred mobile server wallet can be identified and in block 350 the payment message can be routed to the preferred mobile server wallet. Otherwise, in block 360 the payment message can be ignored by the filter.

Returning now to FIG. 2, a set of profiles 280 can be provided within the wireless service provider network. Each of the profiles 280 can reference a different merchant with whom a corresponding one of the MSWPs 230 is to be associated. Alternatively, each of the profiles 280 can indicate a commerce standard such as e-commerce markup language which can be processed by the filter plug-in 270. For each one of the profiles 280 which specifies an associated one of the MSWPs 230, the filter plug-in 270 can monitor message traffic originating from the associated one of the MSWPs 230. In this regard, each of the profiles 280 can include a fully qualified uniform resource locator of a merchant Web site in addition to those form tags which can be processed in the merchant Web site. As message traffic flows through the proxy server 240, the filter plug-in 270 can monitor the payment messages 290 for data which matches the filter condition specified in a relevant one of the profiles 280. When the condition has been matched, the specified mobile server wallet can intervene to facilitate the payment transaction.

Notably, by requiring only a plug-in 270 to the proxy server 240, the wireless service provider network can be partnered with other entities who can provide the mobile server wallet functionality to their respective subscribers. In consequence, the wireless service provider network need neither manage nor host the mobile server wallets themselves. Thus, the configuration of the wireless service provider network with the filter plug-in of the present invention can give rise to several advantageous hosting scenarios.

For example, the wireless service provider can host the mobile server wallet giving the provider the ultimate control over mobile commerce transactions through its network. Yet, with control comes responsibility and such a configuration will require the wireless service provider to manage the mobile server wallet. Additionally, where a payment must be guaranteed by a financial institution, the foregoing model can be inappropriate. In this case, the financial institution can host the mobile server wallet which also can guarantee payments. Moreover, the financial institution can gain exposure to the subscriber base of the wireless service provider network and the wireless service provider network can gain exposure to the members of the financial institution.

As yet another alternative, the merchant can host the mobile server wallet. As many merchants already store account data for on-line shoppers, the data can be migrated to the mobile server wallet with ease and an “ease of shopping” experience for selectively configured ones of the merchants can be marketed to subscribers in the wireless service provider network. In comparison to a merchant hosting scenario, the mobile server wallet can be hosted in a portal using a “walled garden” approach. Shoppers can be provided with a large number of mobile merchants and a mobile server wallet with which purchases can be transacted in the mobile merchants. Finally, an Internet service provider can host the mobile server wallet.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A mobile commerce system comprising:
a plurality of mobile server wallets each wallet having an association with a corresponding subscriber in a wireless service provider network;
a proxy server disposed in said wireless service provider network; and,
a filter plug-in coupled to said proxy server and configured to intercept selected payment messages flowing through the proxy server and to route said payment messages to selected ones of said mobile server wallets.

2. The mobile commerce system of claim 1, further comprising a plurality of profiles communicatively linked to said filter plug-in, each of said profiles specifying a merchant configured to engage in mobile commerce transactions through said wireless service provider network, said filter plug-in having a further configuration for routing said payment messages said selected ones of said mobile server wallets when a source of said payment messages matches a merchant identity specified in at least one of said profiles.

3. The mobile commerce system of claim 1, wherein individual ones of said mobile server wallets are disposed in at least one of an Internet service provider server, said wireless service provider network server, a merchant server, a financial institution server and a portal server.

4. The mobile commerce system of claim 2, wherein at least one of said profiles further comprises a specification of a markup language able to be processed in said filter plug-in.

5. A method for processing mobile commerce transactions in a wireless service provider network, the method comprising the steps of:
filtering payment messages flowing between merchants and subscribers to the wireless service provider network to identify specific payment messages associated with specific subscribers in the wireless service provider network; and,
routing filtered ones of said payment messages to specified mobile server wallets associated with said specific subscribers.

6. The method of claim 5, further comprising the steps of:
consulting filters which specify specific ones of said merchants;
monitoring message traffic flowing from said merchants; and,
intervening in purchase transactions originating in said merchants.

7. The method of claim 5, wherein said routing step comprises routing filtered ones of said payment message to specified mobile server wallets associated with said specific subscribers and positioned outside of the wireless service provider network.

8. The method of claim 5, wherein said routing step comprising routing filtered ones of said payment messages to specified mobile server wallets associated with said specific subscribers and selected by said specific subscribers.

9. A machine readable storage having stored thereon a computer program for processing mobile commerce transactions in a wireless service provider network, the computer program comprising a routine set of instructions for causing the machine to perform the steps of:
filtering payment messages flowing between merchants and subscribers to the wireless service provider network to identify specific payment messages associated with specific subscribers in the wireless service provider network; and,
routing filtered ones of said payment messages to specified mobile server wallets associated with said specific subscribers.

10. The machine readable storage of claim 9, further comprising the steps of:
consulting filters which specify specific ones of said merchants;
monitoring message traffic flowing from said merchants; and,
intervening in purchase transactions originating in said merchants.

11. The machine readable storage of claim 9, wherein said routing step comprises routing filtered ones of said payment message to specified mobile server wallets associated with said specific subscribers and positioned outside of the wireless service provider network.

12. The machine readable storage of claim 9, wherein said routing step comprising routing filtered ones of said payment messages to specified mobile server wallets associated with said specific subscribers and selected by said specific subscribers.
